(19) United States
(12) Patent Application Publication
(10) Pub. No.: US 2013/0166175 A1
(43) Pub. Date: Jun. 27, 2013

(54) SENSOR AND CONTROL DEVICE

(71) Applicant: AISAN KOGYO KABUSHIKI KAISHA, Aichi-ken (JP)

(72) Inventor: Nobuhiro Kato, Aichi-ken (JP)

(73) Assignee: AISAN KOGYO KABUSHIKI KAISHA, Aichi-ken (JP)

(21) Appl. No.: 13/712,019

(22) Filed: Dec. 12, 2012

(30) Foreign Application Priority Data
Dec. 27, 2011 (JP) 2011-286233

(51) Int. Cl. G01N 9/00; G01K 13/00

(52) U.S. Cl. CPC G01N 9/00; G01K 13/00
USPC 701/103; 374/142

(57) ABSTRACT

A sensor may be configured to be disposed in a fuel tank. The sensor may comprise a density detecting unit and a temperature detecting unit. The density detecting unit may be configured to detect a density of a specific substance included in fuel in the fuel tank. The temperature detecting unit may be configured to be located below the density detecting unit and detect a temperature of the fuel.

### CROSS-REFERENCE TO RELATED APPLICATIONS

This application claims priorities to Japanese Patent Application No. 2011-286233, filed on Dec. 27, 2011, the contents of which are hereby incorporated by reference into the present application.

### TECHNICAL FIELD

This specification discloses a sensor device that detects a temperature and a density of fuel.

### DESCRIPTION OF RELATED ART

Japanese Patent Application Publication No. 2010-210285 discloses a sensor device that detects a temperature and a density of blended fuel that includes ethanol, gasoline, and water.

### SUMMARY

In a case of detecting parameters of fuel such as the temperature thereof, it is preferable to dispose a sensor device in a fuel tank and detect the parameters directly from fuel in the fuel tank. However, apparatuses such as a fuel pump are accommodated in the fuel tank. Thus, in a case where the sensor device is disposed in the fuel tank, it is requested to use the inner space of the fuel tank effectively. This specification provides a sensor device which may be suitably disposed in the fuel tank.

In order to solve the problems above, the inventor of the teachings herein found that the following situation may occur. That is, for example, rainwater may enter into the fuel tank, or condensation may occur in the fuel tank so that water may accumulate in a bottom portion of the fuel tank. In a case where a sensor device is disposed in. the fuel tank to detect a density of a specific substance in fuel, if a density detecting unit is disposed near the bottom portion of the fuel tank, the density detecting unit may be immersed in water, and the density of the specific substance may not be detected appropriately. In view of the above situation, the inventor of the teachings herein has created a sensor device capable of using the internal space of the fuel tank effectively.

Teachings disclosed herein is a sensor configured to be disposed in a fuel tank. The sensor may comprise a density detecting unit configured to detect a density of a specific substance included in fuel in the fuel tank; and a temperature detecting unit configured to be located below the density detecting unit and detect a temperature of the fuel.

The above-described undesirable situation may be avoided by disposing the density detecting unit at such a position that is separated to some extent above from the bottom portion of the fuel tank. That is, the above-described undesirable situation can be avoided by interposing a space between the density detecting unit and the bottom portion of the fuel tank. On the other hand, the temperature of water accumulated in the fuel tank is approximately the same as the temperature of fuel. Thus, the temperature of fuel appropriately may be detected even if the temperature detecting unit is immersed in the water near the bottom portion of the fuel tank. In the above configuration, the temperature detecting unit is disposed in ₜhe space between the density detecting unit and the bottom portion of the fuel tank. According to this configuration, the sensor device may be disposed appropriately in the fuel tank by effectively using the space of the fuel tank.

### BRIEF DESCRIPTION OF THE DRAWINGS

FIG. 1 schematically shows a control device according to a first embodiment.

FIG. 2 schematically shows a control device according to a second embodiment.

FIG. 3 shows one surface side of a control device according to a third embodiment.

FIG. 4 shows another surface side of the sensor device according to the third embodiment.

FIG. 5 shows a sensor device according to a fourth embodiment.

### DETAILED DESCRIPTION

Representative, non-limiting examples of the present invention will now be described in further detail with reference to the attached drawings. This detailed description is merely intended to teach a person of skill in the art further details for practicing preferred aspects of the present teachings and is not intended to limit the scope of the invention. Furthermore, each of the additional features and teachings disclosed below may be utilized separately or in conjunction with other features and teachings to provide improved sensors and control devices therefor, as well as methods for using and manufacturing the same.

Moreover, combinations of features and steps disclosed in the following detailed description may not be necessary to practice the invention in the broadest sense, and are instead taught merely to particularly describe representative examples of the invention. Furthermore, various features of the below-described representative examples, as well as the various independent and dependent claims, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter,. independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

The sensor disclosed herein may further comprise a substrate on which the density detecting unit and temperature detecting unit are disposed. According to this configuration, the space required for disposing the sensor device may he decreased as compared to a case where the temperature detecting unit and the density detecting unit are provided on separate substrates.

The sensor disclosed herein may further comprise a level detecting unit configured to detect a level of the fuel. The level detecting unit and the density detecting unit may he arranged along a horizontal direction on one side of the substrate. Alternatively, the density detecting unit may be disposed on one side of the substrate, and the level detecting unit may be disposed on another side of the substrate. According to these configurations, the space required for disposing the sensor device may be decreased as compared to a case where the level detecting unit is provided on a substrate different from the substrate where the temperature detecting unit and the density detecting unit are disposed.

The temperature detecting unit of the sensor disclosed herein may be a thermistor, and the density detecting unit may be a pair of electrodes. The sensor may further comprise a switch configured to switch a state of the sensor between a first state in Which a signal is supplied to the temperature detecting unit and a second state in which a signal is supplied to one of the pair of electrodes of the density detecting unit. According to this configuration, by acquiring the signal from the temperature detecting unit in the first state, the resistance value of the temperature detecting unit correlated with the temperature of fuel may be specified. Moreover, by acquiring the signal from the density detecting unit in the second state, the electrostatic capacitance of the density detecting unit correlated with the density of the specific substance may be specified. That is, according to the above configuration, by changing the detecting unit that supplies a signal using the switch, both the temperature of the fuel and the density of the specific substance may be detected.

The sensor disclosed herein may be used in a control device configured to control a supply of fuel from a fuel tank to an engine. For example, the control unit disclosed herein may comprise the above-described sensor device; a specifying unit configured to specify a temperature of the fuel and a density of a specific substance in the fuel by acquiring a detection result detected by the sensor device; and a controlling unit configured to control an injector injecting the fuel to the engine using the specified temperature and density. According to this configuration, the temperature of the fuel and the density of the specific substance within the fuel are specified using the detection result detected by the sensor device in the fuel tank. Moreover, the injector may be controlled using the specified temperature and density. Since the sensor device is disposed appropriately in the fuel tank, the injector may be controlled using more appropriate temperature and density as compared to a configuration in Which the sensor device is disposed outside the fuel tank.

The engine may connect with a canister absorbing the fuel vaporized in the fuel tank. In this case, the controlling unit may be configured to control a switching device switching a path connecting the canister with the engine between an opened state and a closed state. According to this configuration, the switching device may be controlled using the temperature and density detected within the fuel tank.

The specifying unit and the controlling unit may be configured separately. One output line for supplying the specified temperature and density from the specifying unit to the controlling unit may be wired between the specifying unit and the controlling unit. The specifying unit may be configured to output sequentially the specified temperature and density to the controlling unit. According to this configuration, the wiring may be simplified.

### EMBODIMENT

### First Embodiment

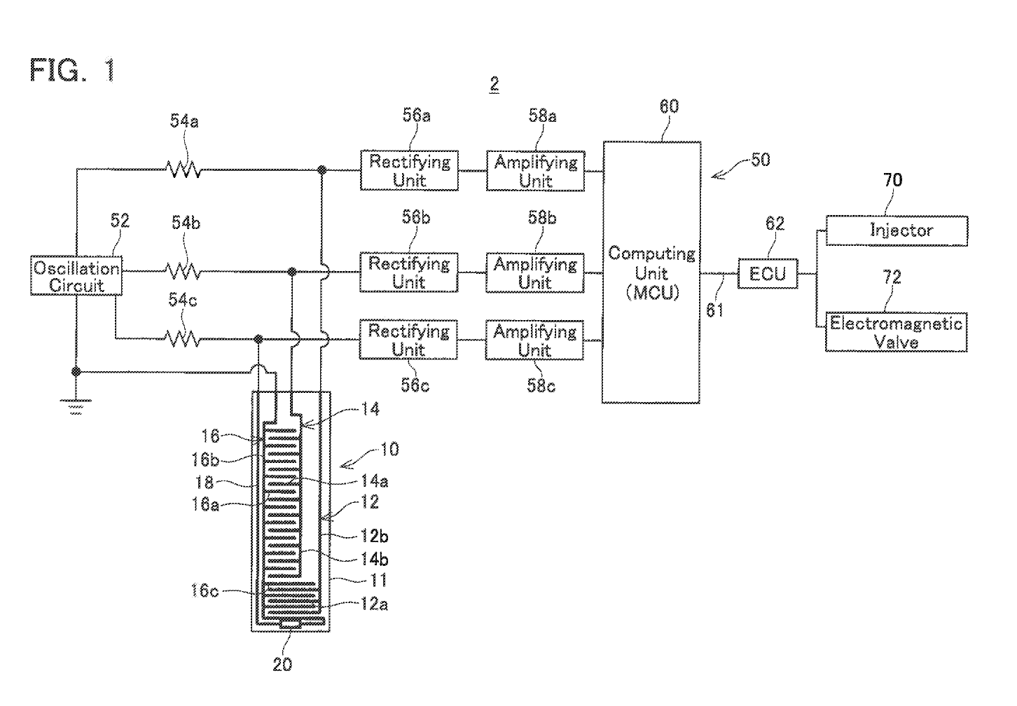

As shown in FIG. 1, a control device 2 comprises a sensor device 10, a specifying device 50, and an engine control unit (ECU) 62. The control device 2 is mounted on an automobile that uses blended fuel of gasoline and ethanol as its fuel.

The sensor device 10 comprises a substrate 11, a density electrode 12, a level electrode 14, a reference electrode 16, a thermistor electrode 18, and a thermistor 20. The substrate 11 is a rectangular flat plate. The respective units 12, 14, 16, 18, and 20 are disposed on one surface of the substrate 11.

The density electrode 12 comprises a plurality of (three in FIG. 1) first electrode portions 12a (only one of the first electrode portions 12a is denoted by a reference numeral in FIG. 1) and a second electrode portion 12b. The second electrode portion 12b extends linearly in a longitudinal direction (i.e., a depth direction of a fuel tank) of the substrate 11. An upper end of the second electrode portion 12b is positioned at an upper end of the substrate 11. The second electrode portion 12b is connected to one set of ends (i.e., the right ends in FIG. 1) of the plurality of first electrode portions 12a. Due to this, the plurality of first electrode portions 12a is electrically connected to the second electrode portion 12b. The plurality of first electrode portions 12a is disposed in parallel to each other and is disposed vertically to the second electrode portion 12b. The plurality of first electrode portions 12a is disposed at an equal interval in the longitudinal direction of the substrate 11. The lower end of the density electrode 12 is disposed at least 1.0 cm above from the lower end of the substrate 11.

The level electrode 14 is disposed on the left side of the density electrode 12. The level electrode 14 is disposed on an upper side than the first electrode portion 12a of the density electrode 12. The level electrode 14 comprises a plurality of (ten in FIG. 1) first electrode portions 14a (only one of the first electrode portions 14a is denoted by a reference numeral in FIG. 1) and a second electrode portion 14b. The second electrode portion 14b extends in the longitudinal direction of the substrate 11. That is, the second electrode portion 14b is disposed in parallel to the second electrode portion 12b of the density electrode 12. The upper end of the second electrode portion 14b is positioned at the upper end of the substrate 11. The second electrode portion 14b is connected to one set of ends (i.e., the right ends in FIG. 1) of the plurality of first electrode portions 14a. Due to this, the plurality of first electrode portions 14a is electrically connected to the second electrode portion 14b, The plurality of first electrode portions 14a is disposed in parallel to each other and is disposed vertically to the second electrode portion 14b. That is, the plurality of first electrode portions 14a is disposed in parallel to the first electrode portions 12a of the density electrode 12. The plurality of first electrode portions 14a is disposed at an equal interval in the longitudinal direction of the substrate 11.

The reference electrode 16 is disposed on the left side of the level electrode 14. The reference electrode 16 comprises a plurality of (ten in FIG. 1) third electrode portions 16a (only one of the third electrode portions 16a is denoted by a reference numeral in FIG. 1), a plurality of (three in FIG. 1) fourth electrode portions 16c, and a fifth electrode portion 16b. The fifth electrode portion 16b extends in the longitudinal direction of the substrate 11. The upper end of the fifth electrode portion 16b is positioned at the upper end of the substrate 11. The fifth electrode portion 16b is connected to one set of ends (the left ends in FIG. 1) of the plurality of third electrode portions 16a and the plurality of fourth electrode portions 16e. Due to this, the plurality of third electrode portions 16a and the plurality of fourth electrode portions 16c are electrically connected to the fifth electrode portion 16b.

The plurality of third electrode portions 16a is disposed in a range where the third electrode portions 16a overlap the level electrode 14 in the longitudinal direction of the substrate 11. The plurality of third electrode portions 16a is disposed in parallel to each other and is disposed vertically to the fifth electrode portion 16b. The plurality of third electrode portions 16a is disposed at an equal interval in the longitudinal direction of the substrate 11. When seen along a line extending from the upper end to the lower end of the substrate 11, the third electrode portion 16a and the first electrode portion 14a are disposed alternately.

The plurality of fourth electrode portions 16c is disposed on the lower side than the plurality of third electrode portions 16a and the level electrode 14 in the longitudinal direction of the substrate 11. The plurality of fourth electrode portions 16c is disposed in parallel to each other and is disposed vertically to the fifth electrode portion 16b. The plurality of fourth electrode portions 16e is disposed at an equal interval in the longitudinal direction of the substrate 11. When seen along a line extending from the upper end to the lower end of the substrate 11, the fourth electrode portion 16c and the first electrode portions 12a are disposed alternately.

The fifth electrode portion 16b extends further downward than the lowermost one of the fourth electrode portions 16c and the lowermost one of the first electrode portions 12a. The lower end of the fifth electrode portion 16b extends rightward in parallel to the plurality of fourth electrode portions 16c. The right end of the fifth electrode portion 16b extends over the second electrode portion 12b of the density electrode 12 and reaches the vicinity of the right end of the substrate 11. The fifth electrode portion 16b is folded at the right end thereof and exₜends toward the left side.

The fifth electrode portion 16b is connected to the thermistor 20 at the vicinity of the lower end of the substrate 11. That is, the thermistor 20 is disposed on the lower side than the density electrode 12 and the level electrode 14. The thermistor electrode 18 is connected to a side (i.e., the left side) of the thermistor 20 opposite to a side where the fifth electrode portion 16b is connected. The thermistor electrode 18 extends leftward from the thermistor 20 and then extends from the lower side to the upper side. The upper end of the thermistor electrode 18 is positioned at the upper end of the substrate 11. As a modification, a temperature detecting element such as a platinum resistance temperature detector in which the output characteristics such as current change with a temperature may he used instead of the thermistor 20.

In a case where the sensor device 10 is disposed in the fuel tank, the lower end of the substrate 11 is disposed to be in contact with the lower surface of the fuel tank. As a result, the thermistor 20 is positioned near the bottom portion of the fuel tank. The lower end of the density electrode 12 is positioned at least 1.0 cm above from the lower surface of the fuel tank.

The specifying device 50 comprises an oscillation circuit 52, three resistors 54a to 54e, three rectifying units 56a to 56c, three amplifying units 58a to 58c, and a computing unit 60. The oscillation circuit 52 generates a signal (i.e., voltage) of a predetermined frequency (for example, 10 Hz to 3 MHz).

The oscillation circuit 52 is connected to the upper end of the density electrode 12 via the resistor 54a, the upper end of the level electrode 14 via the resistor 54b, and the upper end of the thermistor electrode 18 via the resistor 54c. According to this configuration, since the resistance values of the three resistors 54a to 54c can be set individually, it is possible to individually adjust the amplitudes of the signals (i.e., the magnitudes of voltage) supplied to the respective electrodes 12, 14, and 18.

The upper end of the fifth electrode portion 16b of the reference electrode 16 is connected to the ground electric potential. When a signal is supplied from the oscillation circuit 52 to the thermistor electrode 18, the signal is supplied to the thermistor 20. The resistance value of the thermistor 20 changes in correlation with the temperature of the fuel. Since the resistance value of the resistor 54c is constant, the amplitude of the signal supplied to the thermistor 20, that is, the signal supplied to the thermistor electrode 18, changes in correlation with the temperature of the fuel.

When a signal is supplied from the oscillation circuit 52 to the density electrode 12, electric charge is stored between the density electrode 12 and the reference electrode 16, mainly between the first electrode portion 12a and the fourth electrode portion 16c. The electrostatic capacitance between the density electrode 12 and the reference electrode 16 is correlated with the density of ethanol in the fuel. That is, the density of ethanol in the fuel is detected in a range of portions where the first electrode portion 12a and the fourth electrode portion 16c are positioned. Further, the electrostatic capacitance between the density electrode 12 and the reference electrode 16 is correlated with the temperature of the fuel. Since the resistance value of the resistor 54b is constant, the amplitude of the signal supplied to the density electrode 12 changes in correlation with the temperature of the fuel and the density of the ethanol.

When a signal is supplied from the oscillation circuit 52 to the level electrode 14, electric charge is stored between the level electrode 14 and the reference electrode 16, mainly between the first electrode portion 14a and the third electrode portion 16a. The electrostatic capacitance between the level electrode 14 and the reference electrode 16 is correlated with the length of a portion of the level electrode 14 immersed in the fuel, that is the level of the fuel in the fuel tank. That is, the level of the fuel is detected in a range of portions where the first electrode portion 14a and the third electrode portion 16a arc positioned. Further, the electrostatic capacitance between the level electrode 14 and the reference electrode 16 is correlated with the density of the ethanol in the fuel. Since the resistance value of the resistor 54c is constant, the amplitude of the signal supplied to the level electrode 14 changes in correlation with the level of the fuel and the density of the ethanol.

The rectifying unit 56a is connected between the resistor 54a and the density electrode 12. When a signal is supplied from the oscillation circuit 52 to the density electrode 12, the same signal as the signal supplied to the density electrode 12 is input to the rectifying unit 56a. The rectifying unit 56a rectifies the input signal and outputs the rectified signal to the amplifying unit 58a. The amplifying unit 58a amplifies the input signal and outputs the amplified signal to the computing unit 60 (MCU).

Similarly, the rectifying unit 56b is connected between the resistor 54b and the level electrode 14, and the rectifying unit 56c is connected between the resistor 54c and the thermistor electrode 18. When a signal is supplied from the oscillation circuit 52, the same signal as the signal input to the level electrode 14 is input to the rectifying unit 56b, and the same signal as the signal input to the thermistor electrode 18 (i.e., the thermistor 20) is input to the rectifying unit 56c. As a result, a signal which is rectified by the rectifying unit 56b and amplified by the amplifying unit 58b and a signal which is rectified by the rectifying unit 560 and amplified by the amplifying unit 58c are input to the computing unit 60.

The computing unit 60 stores a temperature database, an ethanol density database, and a level database in advance. The temperature database shows a correlation between the signal input from the amplifying unit 58c, that is the signal correlated with the signal input to the thermistor 20, and the temperature of the blended fuel. The ethanol density database shows a correlation between the signal input from the amplifying unit 58a, that is the signal correlated with the signal input to the density electrode 12, the temperature of the blended fuel, and the density of the ethanol included in the blended fuel. The level database shows a correlation between the density of the ethanol included in the blended fuel and the signal input from the amplifying unit 58b, that is the signal correlated with the signal input to the level, electrode 14. The computing unit 60 may store mathematical formula for calculating the temperature or the like of the blended fuel using the input signals instead of storing the respective databases.

The computing unit 60 specifies the temperature of the blended fuel, the ethanol density, and the level using the respective databases and the signals input from the amplifying units 58a to 58c. The computing unit 60 supplies the specified blended fuel temperature, ethanol density, and level to the ECU 62. The computing unit 60 and the ECU 62 arc connected by one output line 61. The computing unit 60 sequentially outputs the specified blended fuel temperature, ethanol density, and level via one output line 61. According to this configuration, it is possible to decrease the number of ports and wires of the ECU 62 as compared to a configuration in which output lines corresponding to the specified blended fuel temperature, ethanol density, and level are provided separately.

The ECU 62 controls an injector 70 and an electromagnetic valve 72 using the blended fuel temperature and the ethanol density supplied from the computing unit 60. The injector 70 communicates with a fuel tank module (not shown) disposed within the fuel tank. The injector 70 injects fuel in a cylinder (not shown) of an engine. The ECU 62 controls an injection amount (an opened period of the injector 70) of the fuel by the injector 70 using the ethanol density acquired from the computing unit 60. Specifically, ethanol has lower caloric power per the same volume as compared to gasoline. Thus, in a case where the density of the ethanol in the blended fuel is high (i.e., in a case where the gasoline density is low), the opened period of the injector 70 is increased so as to increase the amount of injected fuel as compared to in a case where the density of the ethanol in the blended fuel is low (i.e., in a case where the gasoline density is high).

The electromagnetic valve 72 switches between an opened state where a communication path that communicates between a canister (not shown) and an intake pipe of the engine is opened and a closed state where the communication path is closed. The canister includes an adsorbent that adsorbs the fuel vaporized in the fuel tank. In a case where the electromagnetic valve 72 is in the opened state, the fuel adsorbed to the canister is supplied (purged) to the engine. The ECU 62 controls a period in which the electromagnetic valve 7 maintained in the opened state using the ethanol density and the temperature acquired from the computing unit 60. Specifically, the vaporizability of the blended fuel changes depending on the density of the ethanol and the temperature of the blended fuel. For example, when the temperature of the blended. fuel increases, the blended fuel is easily vaporized. Moreover, for example, as the density of the ethanol in the blended fuel increases, the vapor pressure of the blended fuel decreases and the blended fuel is easily vaporized. As a result, the amount of the fuel adsorbed to the canister changes. Thus, it is necessary to prevent the occurrence of a situation in which the amount of fuel purged from the canister to the engine changes due to the amount of the fuel adsorbed to the canister. Such a situation can be suppressed. from occurring by controlling the period in which the electromagnetic valve 72 is maintained in the opened state using the ethanol density and the temperature.

Moreover, the ECU 62 modifies an indicator that displays a residual fuel amount using the supplied level.

Water may accumulate in the fuel tank due to entering rainwater or condensation. Since water has a larger specific gravity than fuel, water accumulates in the bottom portion of the fuel tank. Although the amount of water in the fuel tank decreases with evaporation thereof, water may remain near (e.g., at a distance of approximately 1 cm above) the bottom portion of the fuel tank. The density electrode 12 of the sensor device 10 is disposed at least 1 cm above from the lower end of the substrate 11. Thus, when the sensor device 10 is disposed so that the lower end of the substrate 11 is in contact with the bottom portion of the fuel tank, the density electrode 12 is disposed at least 1 cm above from the bottom portion of the fuel tank, As a result, the density electrode 12 can be prevented from being immersed in the water that remains near the bottom portion of the fuel tank. According to the sensor device 10, it is not necessary to minutely adjust the arrangement as long as the lower end of the substrate 11 is disposed to be in contact with the bottom portion of the fuel tank.

Moreover, in the sensor device 10, the thermistor 20 is positioned on the lower side than the density electrode 12. In a case where water accumulates near the bottom portion of the fuel tank, there is not a great difference between the temperature of the fuel in the fuel tank and the temperature of water. Thus, it is possible to appropriately detect the temperature of the fuel even if the thermistor 20 is disposed in a range of portions near the bottom portion of the fuel tank where water accumulates. According to the sensor device 10, it is possible to effectively use the space by disposing the thermistor 20 on the lower side of the density electrode 12.

Further, it is possible to decrease the space occupied by the sensor device 10 by disposing the respective electrodes 12, 14, 16, and 18 on the same substrate 11.

### Second Embodiment

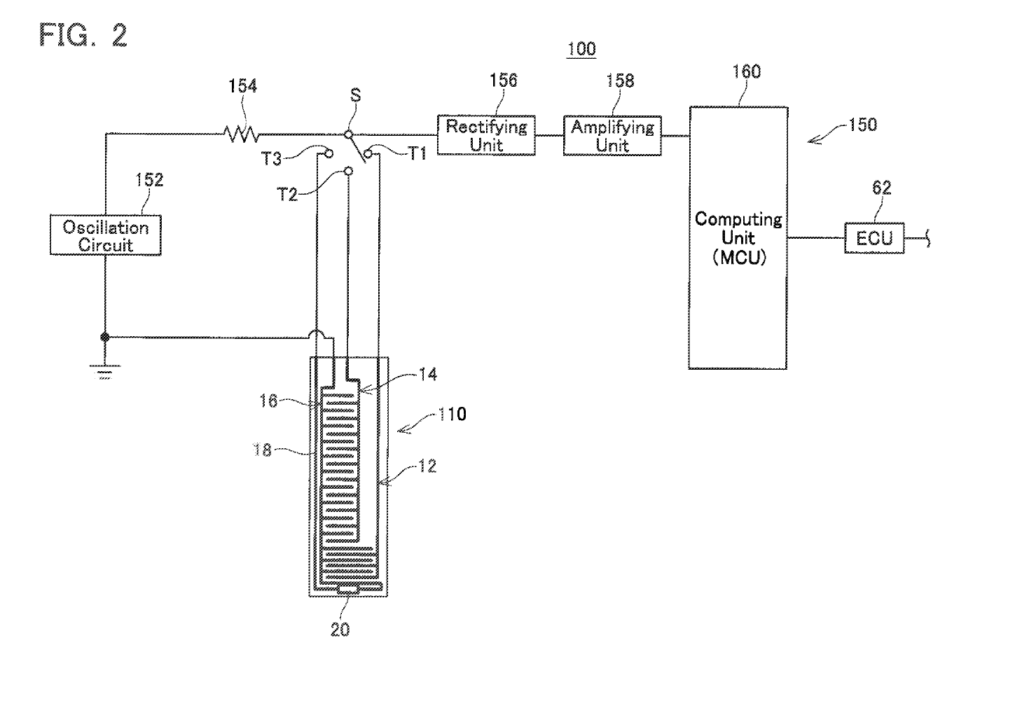

As shown in FIG. 2, a control device 100 according to the second embodiment comprises a sensor device 110, a specifying device 150, and an ECU 62. The ECU 62 has the same configuration as the ECU 62 of the first embodiment.

The sensor device 110 comprises respective units 11, 12, 14, 16, and 18 and the like similarly to the sensor device 10. The sensor device 110 further comprises a switch S.

The specifying device 150 comprises an oscillation circuit 152, a resistor 154, a rectifying unit 156, an. amplifying unit 158, and a computing unit (MCU) 160. The oscillation circuit 152 and the computing unit 160 have the same configurations as the oscillation circuit 52 and the computing unit 60 of the first embodiment, respectively. The rectifying unit 156 is connected to the switch S.

The switch S is connected to the oscillation circuit 152 via the resistor 154. The switch S selectively connects any one of terminals T1 to T3 to the oscillation circuit 152.

When the switch S is switched to a state where the terminal T1 and the oscillation circuit 152 are connected, a signal from the oscillation circuit 152 is supplied to the density electrode 12. As a result, the same signal as the signal input to the density electrode 12 is input to the rectifying unit 156. When the switch S is switched to a state where the terminal T2 and the oscillation circuit 152 are connected, a signal from the oscillation circuit 152 is supplied to the level electrode 14. As a result, the same signal as the signal input to the level electrode 14 is input to the rectifying unit 156. When the switch S is switched to a state where the terminal 13 and the oscillation circuit 152 are connected, a signal from the oscillation circuit 152 is supplied to the thermistor electrode 18. As a result, the same signal as the signal input to the thermistor electrode 18 is input to the rectifying unit 156. The rectifying unit 156 rectifies the input signal. and outputs the rectified signal to the amplifying unit 158. The amplifying unit 158 amplifies the input signal and outputs the amplified signal to the computing unit 160.

The processes performed after the signals are input to the computing unit 160 are the same as those of the first embodiment.

In the second embodiment, the same advantages as those of the first embodiment can be obtained. Moreover, the signal output from the oscillation circuit 152 is supplied to any one of the respective electrodes 12, 14, and 18 according to the switch S. According to this configuration, it is not necessary to dispose a plurality of resistors between the oscillation circuit 152 and the substrate 11. Moreover, since the rectifying unit 156 is connected to the switch S, it is not necessary to dispose a plurality of rectifying units.

### Third Embodiment

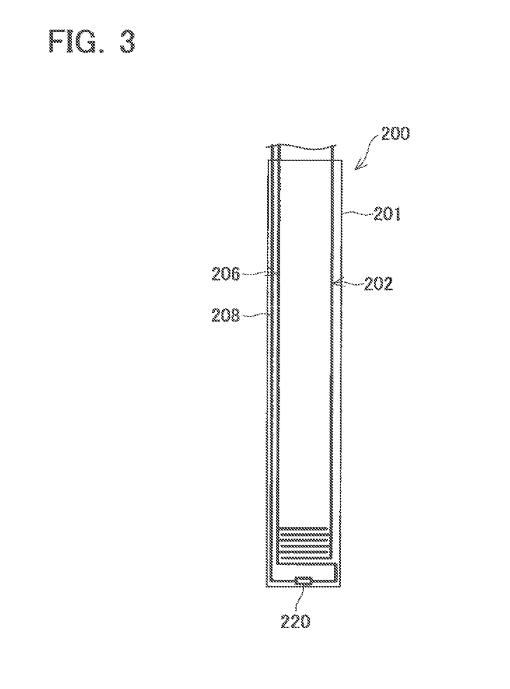

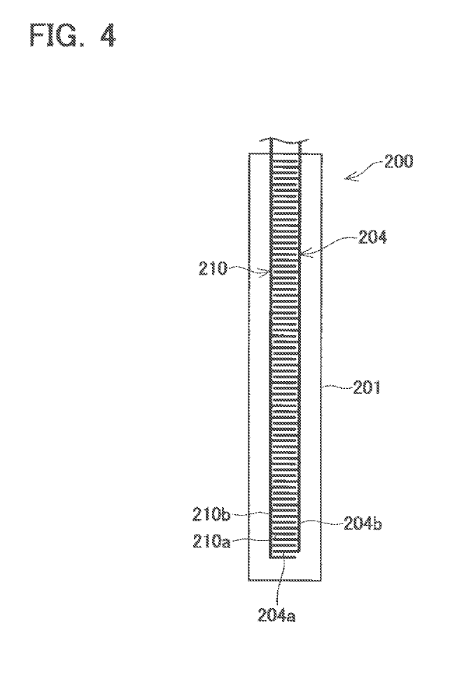

A sensor device 200 shown in FIGS. 3 and 4 may he disposed instead of the sensor device 10 of the control devices 2 and 100. As shown in FIG. 3, a density electrode 202, a reference electrode 206, a thermistor electrode 208, and a thermistor 220 are disposed on one surface side of a substrate 201 of the sensor device 200. The density electrode 202 has the same configuration as the density electrode 12 of the first embodiment The reference electrode 206 has the same configuration as the reference electrode 16 of the first embodiment, except that the third electrode portion 16a is not included. The thermistor electrode 208 has the same configuration as the thermistor electrode 18 of the first embodiment.

The thermistor 220 is disposed between the reference electrode 206 and the thermistor electrode 208 similarly to the thermistor 20 of the first embodiment.

As shown in FIG. 4, the level electrode 204 and the reference electrode 210 are disposed on another surface of the substrate 201. The level electrode 204 comprises a plurality of (thirty four in FIG. 4) first electrode portions 204a (only one of the first electrode portions 204a is denoted by a reference numeral in FIG. 4) and a second electrode portion 204b similarly to the level electrode 14 of the first embodiment. The first electrode portions 204a correspond to the first electrode portions 14a and the second electrode portion 204b corresponds to the second electrode portion 14b.

The reference electrode 210 comprises a plurality of (thirty four in FIG. 4) sixth electrode portions 210a (only one of the sixth electrode portions 210a is denoted by a reference numeral in FIG. 4) and a seventh electrode portion 210b. The seventh electrode portion 210b extends linearly in the longitudinal direction (the depth direction of the fuel tank) of the substrate 201. The upper end of the seventh electrode portion 210b is positioned at the upper end of the substrate 201. The upper end of the seventh electrode portion 210b is connected to the ground electric potential. The seventh electrode portion 210b is connected to one set of ends (i.e., the ends in FIG. 4) of the plurality of sixth electrode portions 210a. Due to this, the plurality of sixth electrode portions 210a is electrically connected to the seventh electrode portion 210b. The plurality of sixth electrodes, portions 210a is disposed in parallel to each other and is disposed vertically to the seventh electrode portion 210b. The plurality of sixth electrode portions 210a is disposed at an equal interval in the longitudinal direction of the substrate 201.

According to the sensor device 200, the same advantages as those of the sensor device 10 of the first embodiment can be obtained. Moreover, the density electrode 202, the reference electrode 206, the thermistor electrode 208, and the thermistor 220 are disposed on a surface opposite to the level electrode 204. According to this configuration, it is possible to increase the length of the level electrode 204. As a result, it is possible to increase the electrostatic capacitance of the level electrode 204. Thus, it is possible to increase the amplitude of the change in the electrostatic capacitance that is correlated with the change in the level.

### Fourth Embodiment

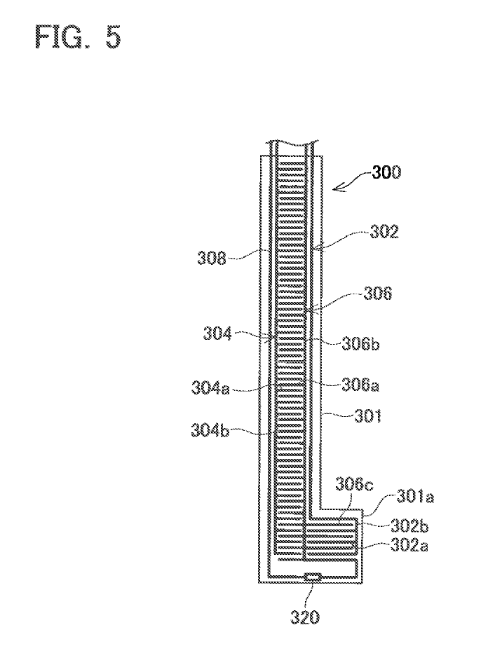

A sensor device 300 shown in FIG. 5 may be disposed instead of the sensor device 10 of the control devices 2 and 100. As shown in FIG. 5, the sensor device 300 comprises a substrate 301, a density electrode 302, a level electrode 304, a reference electrode 306, and a thermistor electrode 308. The substrate 301 is a flat plate that extends in the vertical direction (i.e., the depth direction of the fuel tank). The width (i.e., the horizontal length) of the substrate 301 is constant except for a portion of a lower end portion 301a. The width of the lower end portion 301a of the substrate 301 is larger than that of the other portions of the substrate 301.

The density electrode 302 comprises a plurality of (three in FIG. 5) first electrode portions 302a (only one of the first electrode portions 302a is denoted by a reference numeral in FIG. 5) and a second electrode portion 302b, The second electrode portion 302b extends linearly in the longitudinal direction (i.e., the depth direction of the fuel tank) from the upper end of the substrate 301. The second electrode portion 302b is bent rightward at a right angle and extends rightward when the second electrode portion 302b reaches the lower end portion 301a. The second electrode portion 302b is bent downward at a right angle and extends downward when the second electrode portion 302b reaches near the right end of the lower end portion 301a. The lower end of the second electrode portion 302b is positioned on the upper side of the reference electrode 306 described later. The upper end of the second electrode portion 302b is connected to an oscillation circuit (e.g., the oscillation circuit 52). The lower end of the density electrode 302 is disposed at least 1.0 cm above from the lower end of the substrate 301.

A portion of the second electrode portion 302b located in the lower end portion 301a is connected to one set of ends (i.e., the right ends in FIG. 5) of the plurality of first electrode portions 302a. Due to this, the plurality of first electrode portions 302a is electrically connected to the second electrode portion 302b. The plurality of first electrode portions 302a is disposed in parallel to each other and is disposed vertically to the second electrode portion 302b. The plurality of first electrode portions 302a is disposed at an equal interval in the longitudinal direction of the substrate 301.

The reference electrode 306 is disposed on the left side of the level electrode 302. The reference electrode 306 comprises a plurality of (thirty five in FIG. 5) third electrode portions 306a (only one of the third electrode portions 306a is denoted by a reference numeral in FIG. 5), a plurality of (four in FIG. 5) fourth electrode portions 306c, and a fifth electrode portion 306b. The fifth electrode portion 306b extends linearly in the longitudinal direction of the substrate 301. The upper end of the fifth electrode portion 306b is positioned at the upper end of the substrate 301. The upper end of the fourth electrode portion 306b is connected to the ground electric potential. The fourth electrode portion 306b is connected to one set of ends (the right ends in FIG. 5) of the plurality of third electrode portions 306a. Due to this, the plurality of third electrode portions 306a is electrically connected to the fifth electrode portion 306b.

The plurality of third electrode portions 306a is disposed in parallel to each other and is disposed vertically to the fifth electrode portion 306b. The plurality of third electrode portions 306a is disposed at an equal interval in the longitudinal direction of the substrate 301. The lowermost one of the third electrode portions 306a is positioned on the lower side than the lowermost one of the first electrode portions 304a (described later).

The fifth electrode portion 306b is connected to one set of ends (i.e., the left ends in FIG. 5) of the plurality of fourth electrode portions 306c. Due to this, the plurality of fourth electrode portions 306c. is electrically connected to the fifth electrode portions 306b. The plurality of fourth electrode portions 306c is disposed in parallel to each other and is disposed vertically to the fifth electrode portion 306b. The plurality of fourth electrode portions 306c is disposed at an equal interval in the longitudinal direction of the substrate 301. When seen along a line extending from the upper end to the lower end of the lower end portion 301a, the fourth electrode portions 306c and the first electrode portions 302a are disposed alternately. The lowermost one of the fourth electrode portions 306c is positioned on the lower side than the lowermost one of the first electrode portions 302a. The lowermost one of the fourth electrode portions 306c is disposed at the same position as the lowermost one of the third electrode portions 306a when seen in the vertical direction.

The lowermost one of the fourth electrode portions 306c extends rightward up to a position where the fourth electrode portion 306c is aligned in the vertical direction in relation to the second electrode portion 302b that is positioned in the lower end portion 301a. The fourth electrode portion 306c is folded leftward and is connected to the thermistor 320. Thus, the thermistor 320 is disposed on the lower side than the density electrode 302 and the level electrode 304. The thermistor electrode 308 is connected to a side of the thermistor 320 opposite to the side where the fourth electrode portion 306c is connected. The thermistor electrode 308 extends leftward from the thermistor 320 and then extends upward from the lower side. The upper end of the thermistor electrode 308 is positioned at the upper end of the substrate 301. The upper end of the thermistor electrode 308 is connected to an oscillation circuit (for example, the oscillation circuit 52).

The level electrode 304 is disposed between the reference electrode 306 and the thermistor electrode 308. The level electrode 304 comprises a plurality of (thirty four in FIG. 5) first electrode portions 304a (only one of the first electrode portions 304a is denoted by a reference numeral in FIG. 5) and a second electrode portion 304b. The second electrode portion 304b extends linearly in the longitudinal direction of the substrate 301. The upper end of the second electrode portion 304b is positioned at the upper end of the substrate 301. The upper end of the second electrode portion 304b is connected to an oscillation circuit (e.g., the oscillation circuit 52). The second electrode portion 304b is connected to one set of ends (i.e., the left ends in FIG 5) of the plurality of first electrode portions 304a. Due to this, the plurality of first electrode portions 304a is electrically connected to the second electrode portion 304b.

The plurality of first electrode portions 304a is disposed in a range of portions where the first electrode portions 304a overlap the reference electrode 306 in the longitudinal direction of the substrate 301. The plurality of first electrode portions 304a is disposed in parallel to each other and is disposed vertically to the second electrode portion 304b. The plurality of first electrode portions 306a is disposed at an equal interval in the longitudinal direction of the substrate 301. The lowermost one of the first electrode portions 304a is disposed at the same position as the lowermost one of the first electrode portions 302a when seen in the longitudinal direction of the substrate 301. Thus, the lower end of the level electrode 304 is disposed at least 1.0 cm above from the lower end of the substrate 301.

The second electrode portion 302b, the second electrode portion 304b, the fifth electrode portion 306b, and the portion of the thermistor electrode 308 that extends upward from the lower side are disposed in parallel to each other.

When a signal is supplied from the oscillation circuit to the sensor device 300, in the sensor device 300, the electrostatic capacitance between the level electrode 304 and the reference electrode 306, particularly between the first electrode portion 304a and the third electrode portion 306a changes mainly in correlation with the level of the fuel. Moreover, in the sensor device 300, the electrostatic capacitance between the density electrode 302 and the reference electrode 306, particularly between the first electrode portion 302a and the fourth electrode portion 306c changes mainly in correlation with the density of ethanol in the fuel.

According to the sensor device 300, the same advantages as the sensor device 10 of the first embodiment can be obtained. The range of portions where the level of the fuel is detected and the range of portions where the density of the ethanol in the fuel is detected overlap in the longitudinal direction of the substrate 301. According to this configuration, it is possible to increase the length of the level electrode 304. As a result, it is possible to increase the electrostatic capacitance for detecting the level (that is, the electrostatic capacitance between the first electrode portions 304a and the third electrode portions 306a). Thus, it is possible to increase the amplitude of the change in the electrostatic capacitance that is correlated with the change in the level.

1. A sensor configured to be disposed in a fuel tank, the sensor comprising:
a density detecting unit configured to detect a density of a specific substance included in fuel in the fuel tank; and
a temperature detecting unit configured to be located below the y detecting unit and detect a temperature of the fuel.

2. The sensor as in claim 1, further comprising:
a substrate on which the density detecting unit and temperature detecting unit are disposed.

3. The sensor as in claim 2, further comprising:
a level detecting unit configured to detect a level of the fuel,
wherein the level detecting unit and the density detecting unit are arranged along a horizontal direction on one side of the substrate.

4. The sensor as in claim 2, further comprising:
a level detecting unit configured to detect a level of the fuel,
wherein the density detecting unit is disposed on one side of the substrate, and
the level detecting unit is disposed on another side of the substrate.

5. The sensor as in claim 1, wherein
the temperature detecting unit is a thermistor,
the density detecting unit is a pair of electrodes, and
the sensor further comprises:
a switch configured to switch a state of the sensor between a first state in which a signal is supplied to the temperature detecting unit and a second state in which a signal is supplied to one of the pair of electrodes of the density detecting unit.

6. A control device configured to control a supply of fuel from a fuel tank to an engine, the control unit comprising:
a sensor device as in claim 1;
a specifying unit configured to specify a temperature of the fuel and a density of a specific substance in the fuel by acquiring a detection result detected by the sensor device; and
a controlling unit configured to control an injector injecting the fuel to the engine using the specified temperature and density.

7. The control device as in claim 6, wherein
the engine connects with a canister absorbing the fuel vaporized in the fuel tank, and
the controlling unit is configured to control a switching device switching a path connecting the canister with the engine between an opened state and a closed state.

8. The control device as in claim 6, wherein
the specifying unit and the controlling unit are configured separately,
one output line for supplying the specified temperature and density from the specifying unit to the controlling unit is wired between the specifying unit and the controlling unit, and
the specifying unit is configured to output sequentially the specified temperature and density to the controlling unit.
